(19) United States
(12) Patent Application Publication
(10) Pub. No.: US 2002/0013814 A1
(43) Pub. Date: Jan. 31, 2002

(54) Method of searching for persons using communication means

(76) Inventor: Akira Koto, Tokyo (JP)

Correspondence Address: LAW OFFICE OF JOHN A. GRIECCI, 2201 E. WILLOW ST, STE D, PMB 344, SIGNAL HILL, CA, 90806-2142, US

(21) Appl. No.: 09/858,184

(22) Filed: May 15, 2001

(30) Foreign Application Priority Data
May 18, 2000 (JP) 2000-147032

(51) Int. Cl. G06F 15/16

(52) U.S. Cl. 709/204; 345/753

(57) ABSTRACT

A method of searching for persons is provided, wherein an unspecified number of participants can search for persons who have given the most similar answers or entirely opposite answer in the process of answering several questionnaires using a system wherein an unspecified number of participants are able to answer several questionnaires using the terminals widely distributed among general public as convenient tools such as portable phone, personal computer, etc., and communicate with each other at their request. Said method comprises a connecting step wherein a plurality of participants connect the terminals with the server to place them under mutually communicable conditions, an inputting step wherein each of said participants inputs his personal information to said terminal, a providing step wherein said server provides a questionnaire which has been previously prepared in said server to each participant via said terminal, an answering step wherein said participants answer said questionnaire provided from said server via said terminals, a detecting step wherein said server detect other participants among a plurality of said participants who have given the same or a similar answer and/or other participants among a plurality of participants who have given an opposite answer, and a providing step wherein said server provides an introductory information produced based on said personal information between said other participants who have given the same or a similar answer and/or said other participants who have given an opposite answer and said participant in said detection step.

### BACKGROUND OF THE INVENTION

1. Field of the Invention

The present invention generally relates to a method of searching for persons using a communication means via communication lines such as the internet or telephone line to recruit an unspecified number of participants who are strangers with each other and produce the mutual encounter among said participants.

2. Background Art

Conventionally, everybody has a desire to discover “another one just like me” who would exist in this world.

The above-described “another one just like me” in this world means, for examples a person having the same look or same way of thinking as mine, and conventionally there has been often planned a “look-alike show” for famous talents in the mass-communication program. However, no planning has been so far made to search for persons having a similar way of thinking, and only the empirical analysis has been made on whether “a person has a similar way of thinking as that of another person” or “a person has an entirely opposite way of thinking from that or another person” based on a long term acquaintance.

As described above, it is a primary object of the present invention to provide a method of searching for persons using a communication means capable of performing a real-time mutual encounter with persons who have the same way of thinking to mine or opposite way of thinking to mines and to provide a server (apparatus) capable of using said method.

Furthermore, it is another object of the present invention to make it possible to objectively evaluate such an empirical statement as “he closely looks like another person so-and-so” by one's own trial, which, as mentioned above, has been often evaluated by others (which is difficult for oneself to evaluate), and furthermore, to provide a novel dramatic direction enabling the encounter with persons who hate the same or opposite way of thinking based on said objective evaluation.

This invention can be applied not only to a case of searching for persons who have the same or opposite way of thinking as described above but also a supposed encounter with persons having a similar vision for a particular genre such as “baseball” or the same way of thinking for “politics”. Other genre is exemplified by states, celebrities such as talents, etc.

In view of these circumstances has been made the present invention.

### SUMMARY OF THE INVENTION

In order to solve the above-described problems, this invention employs the following constructions.

Namely, the present invention provides a method of searching for persons using a communication means, said method comprising a plurality of the following steps:

(A) a step whereby a plurality of participants connect their terminals with a server in a condition enabling their mutual communication via a communication means,

(B) a step whereby each of said participants inputs personal information thereof into said server from said terminals,

(C) a step whereby said server provides a questionnaire that has been stored therein to each of said participants via said terminals,

(D) a step whereby said participants answer to said questionnaire provided by said server using said terminals,

(E) a step whereby said server detects other participants among a plurality of said participants who have given the same or a similar answer and/or other participants among a plurality of said participants who have given the opposite answer, and

(F) a step whereby an introductory information prepared based on said mutual personal information is provided via said terminals between said participant and said other participants who have given the same or a similar answer and/or who have given an opposite answer detected by said detection.

Said communication means includes communications via telephone lines, internet lines or wireless system, and this invention can be applied to any of these communication systems.

Said personal information may include address, name, age, gender, credit card number, portable phone number, internet address, information of several tens words for appealing oneself, or ID cord described below, etc., and, furthermore, aid introductory information includes information selected from said personal information, or modified information of said personal information, or said personal information itself.

Furthermore, it may be set up that said personal information will be input every time said person is introduced by this invention via said terminal, but a lot of time and labor can be saved by issuing an ID code from said server at the first time of introduction of said person, and inputting said ID code as said personal information at the time of succeeding introductions by said invention. In this case, said ID code and the previously input personal information are stored corresponding with each other as a lookup table wherein said ID code and said personal information correspond with each other within said server.

In addition, the present invention is characterized in that, besides the method above-describe, a common deadline for answering said questionnaire by a plurality of said participants has been previously set.

Needless to say that a near real-time introduction can be made when said answering deadline is as short as less than a few minutes, and that said answering deadline can be set to one day or several weeks.

It is also possible to use rapidly spreading portable phones in recent years as said terminals, and, in the case where said portable phone is employed as said terminal, it can be arranged so as to answer said questionnaire and be introduced to another persons anytime anywhere in spare time utilizing the feature of portable phone. Furthermore, if said introductory information is comprised to include the portable phone number, it becomes possible to talk to a partner on the spot by the portable phone, and, by doing so, the effect to provide an entirely new “encounter” can be expected.

Further, the present invention is characterized in that an additional step is included after the above-mentioned step (F), which makes it possible to communicate between both said participant and said other participant or among three persons or more. Since, in the case of a real-time performance of the method according to the present invention, it is possible to communicate with a person immediately after answering the questionnaire who is found by searching, the search for person can be carried out without being bored as compared with a case of non-real-time search.

Furthermore, the present invention is characterized in that an additional step is included after said step (E), and prior to said step (F), whereby it is confirmed whether said participants want mutual introductions or not.

And, prior to “said step to confirm whether said participants want mutual introduction or not” and after said step (E) “wherein the server detects other participants out of a plurality of said participants who have given the same or a similar answer and/or other participants out of a plurality of said participants who have given the entirely different answer”, it is also possible to set up a step whereby a preliminary introductory information can be obtained through the terminals so as to judge whether participants want mutual introduction or not. Such a preliminary introductory information is formed from said personal information, and thought to include, for example, the above described “age, gender, profile, etc.”, which are harmless even though acquired by unknown parties. Needless to say, such a step to acquire a preliminary introductory information through the terminals in advance is not essential in this invention, and the introductory information may be presented not through such a step. For example, if said introductory information is merely a mail address, it is possible to sever a connection with an introduced participant by altering said mail address, and also since a recent mall software furnished by Microsoft Corp. has a function to reject a mail from a particular mail address, a connection with an introduced participant will be also severed using such a function.

In the case where said other participant rejects the introduction, it is also possible to set up an additional step to inform a participant of that fact through a display means of said terminal.

Furthermore, the present invention is characterized in that a plurality of questionnaires are previously prepared in the server at said step (C), and steps (C) through (E) are repeated in the server at said step (E) until the detection results or detecting other participants out of a plurality of said participants who have given the same or a similar answer and/or other participants out of a plurality of said participants who have given the opposite answer reach a specific number of people.

It is preferable that the participant side has no authority to decide said specific number of people, which is a number predetermined by the server side. That is because, in case that the participant side had authority to decide a number of people, said number narrowed down by the participants would be different among them, requiring adjustment for it. Namely, it is because there is a risk that one participant has no other corresponding participant based on the method of introduction according to this invention, while another participant may become an object for introduction as the one who has almost the same idea with that participant.

Furthermore, the present invention is characterized in that, in a method of searching for persons using a communication means, wherein said steps (C) through (E) are repeated until the search results of searching other participants out of a plurality of said participants who have given the same or a similar answer and/or other participants out of a plurality of said participants who have given the opposite answer reach a specific number of people in said step (E), in a case where said number of other participants becomes less than the specific number of people, said server returns to the search result of a question one prior to said question, and issues a message to said terminal to urge the participant to prioritize other participants to be mutually introduced, and proceeds to said step (F) in a case where participants who want to be mutually introduced are present based on said order of priority input from said terminal.

Furthermore, the present invention is characterized in that said invention includes a step, wherein, while said steps (C) through (E) are being repeated, said server detects other participants out of a plurality of participants who have given the same or a similar answers and/or other participants out of a plurality of participants who have given the opposite answers, and notifies each participant of the detection results each time via said terminals.

A method for notifying the detection results obtained by repeating said steps (C) through (E) may include the display means of said terminal such as display on liquid crystal, loud speaker for voice display, etc.

Furthermore, the present invention is characterized in that said invention employs a method of selecting one answer out of a plurality of previously prepared answers to said questionnaire by participant's own will.

In the case where portable phone is employed as said terminal, the number of said answer choices is preferably several such as two or three which can be shown on the display of said portable phone.

Furthermore, the present invention is characterized in that said server sets up so that, out of said participant and other participants, a participant who expresses the desire to be introduced to the other participant after confirming his own wish for that introduction will pay the fee for said communication means.

Furthermore, the present invention is characterized in that a server (apparatus) comprises the following compositions:

connecting means for connecting said server to a plurality of terminals enabling them to mutually communicate via the communicating means,

a first memory means which has stored information on a plurality of questionnaires,

controlling means for controlling the appropriate extraction of information on questionnaires from said first memory means, transmission of said extracted information on questionnaires to a plurality of said terminals via said connecting means, receiving of information on answers given based on said information on questionnaires through the operation of terminals via said connecting means, and storing of it in a second memory means,

statistical treatment means for performing statistical treatment based on the information on answers which has been received from each terminal and stored in said second memory means and,

comparing means for comparing the results treated by said statistical treatment means with predetermined values,

and that, when said comparing means judges that the result treated with said statistical treatment means coincides with said pre-set predetermined value, said controlling means controls so as to inform each of said terminals that the result coincides with the predetermined value via said connecting means, and when the said result does not reach the predetermined value, said controlling means controls so as to transfer again said information on answers to each of said terminals.

This invention can be applied to not only a case of searching for persons who have the same or opposite way of thinking but also an assumed encounter with a person who has the same way of thinking on a genre such as “baseball” or with persons who have the same way of thinking on “politics”. Other genre than the above-described ones includes states, celebrities such as talents, etc.

Although different from the above-described two purposes of this invention, a conventional method of bringing strangers close together such as the one using the internet, etc. has been proposed in Japanese Patent application Laid-open No. Hei 6-19926.

In this method, data requested by a partner to whom one user wants to be introduced and data on said participant himself are both registered beforehand, and when requests on both sides are found to be identical or close with each other by comparing data requested by other user with data of that user, an opportunity for having conversation between them is to be provided, In brief, it is as if a formal introduction to a prospective (marriage) partner had been carried out on the internet.

However, since, in the above-described conventional method, data requested by one user is previously registered to carry out the search for other users in accordance with said requested data as if a so-called marriage arrangement were carried out using a communicating means, a suitable partner won't be easily found as a matter of fact when said user has a too high image of the ideal person. That is, a fundamental difference between said system and the present invention lies in that, in contrast to the search for partner in accordance with the requested data in the conventional method, in this invention are searched persons having a similar or entirely opposite way of thinking based on objective information on said persons. Therefore, this invention cannot be easily conducted by simply applying said conventional techniques to the method of searching persons according to this invention.

### BRIEF DESCRIPTION OF THE DRAWINGS

FIG. 1 is a system block diagram of one embodiment which has adopted this invention.

FIG. 2 is a detailed system block diagram depicting the server and terminals of FIG. 1 in more detail.

FIG. 3 is a flow chart describing an embodiment of a method of searching for persons which has adopted this invention.

FIG. 4 is a continuation of the flow chart in FIG. 3.

FIG. 5 is a continuation of the flow chart in FIG. 4.

### DETAILED DESCRIPTION OF THE PREFERRED EMBODIMENT

In the following, a preferred embodiment of a method and a system of searching for persons using a communication means according to this invention will be described.

(Summary) This invention relates to a system wherein an unspecified number of participants are able to answer several questionnaires using the terminal such as portable phone, personal computer, etc. widely spreading among general public as convenient tools, search for someone like me (SLM) who has given an answer most similar to that of one participant himself and someone unlike me (SUM) who has given an entirely opposite answer to that of said participant himself in the process -of answering several questionnaires, and contact with each other as they wish to do so.

(Features) this invention can be applied to a game to find “another one just like me” whom everybody wants to know, and is not only to add up the answers to a questionnaire at once and inform said participants of the added-up results but also to display each participant of the number of persons who have passed the same or a similar judgment on each questionnaire via the above-described terminals giving pleasure to said participant to gradually establish his own identity based on the objective evaluation in this process. Finally, the invention enables a participant to directly communicate with persons who have given the entirely same answer as that of said participant himself to said questionnaire based an the mutual agreement via said terminals, directing an impossible encounter in the ordinary life. The invention also allows a participant to detect persons who have formed an entirely opposite judgment (way of thinking) in answering said questionnaire, and contact such persons at the opposite side in this world according to the mutual agreement.

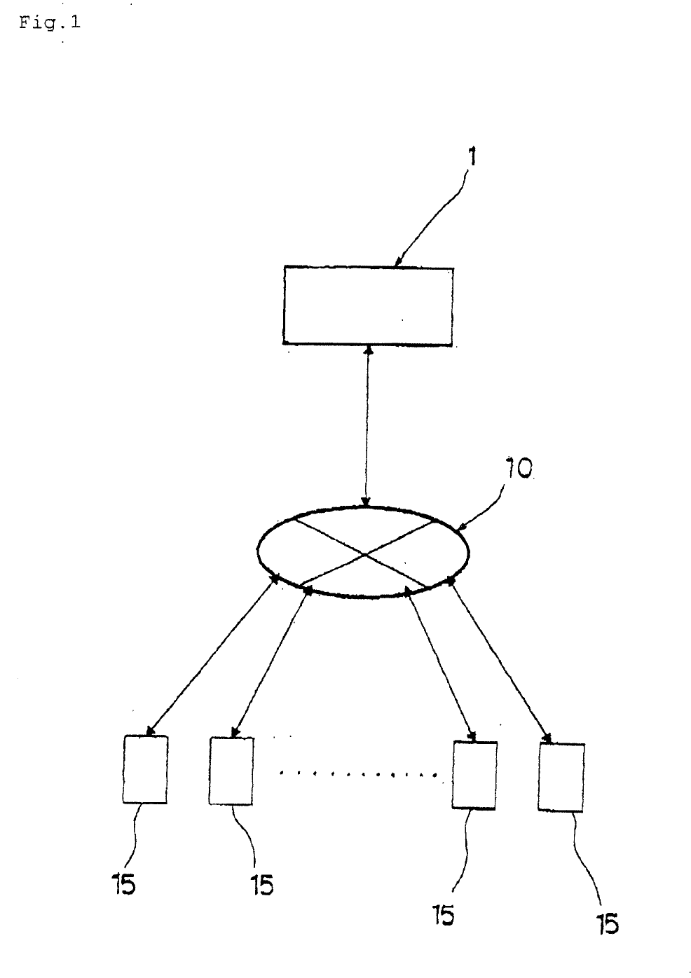

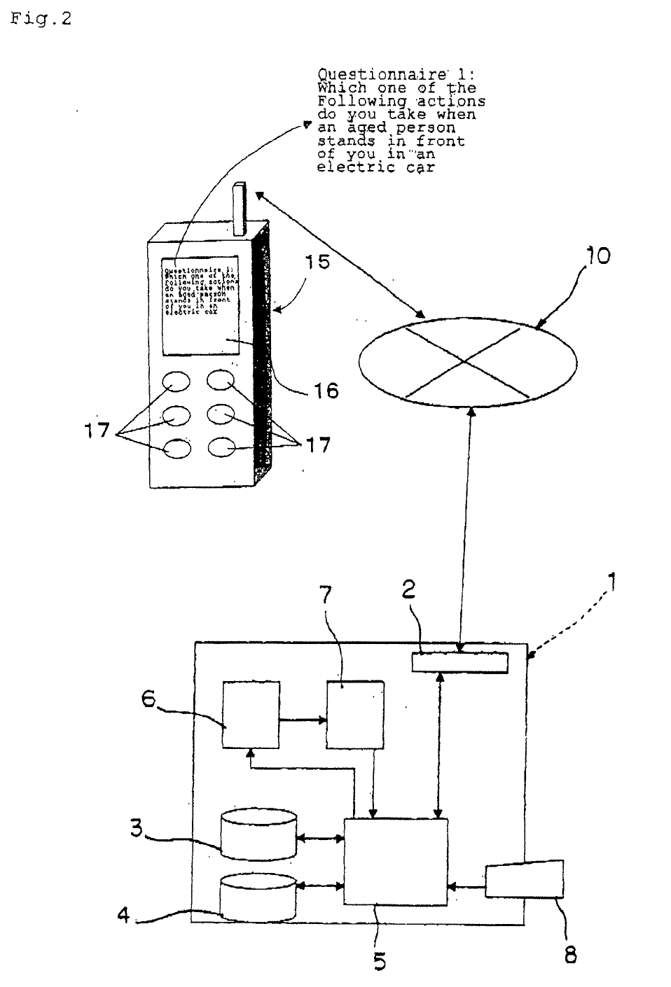

FIG. 1 shows a configuration diagram of the general construction of a system capable of implementing the method of this invention. In this figure, the numeral 1 represents a server, 10 an internet communication network, and 15, . . . 15 terminal each participant has. As said terminal 15 can be appropriately used non-portable personal computer, portable notebook-type personal computer, exclusive terminal, etc., and in this embodiment, as shown in FIG. 2, a portable phone is employed as said terminal 15.

In the following, based on FIG. 2, the system of this embodiment will be described in more detail. As shown in FIG. 2, said terminal 15 is provided with a display means 16 such as a liquid crystal display, etc. and a plurality of button switches 17 . . . 17 as the inputting means for inputting characters or telephone numbers, etc.

On the other hand, said server 1 comprises a connecting means 2 for connecting it with a plurality of terminals 15 . . . 15 via a communicating means 10 as an internet line network which makes them possible to mutually communicate, a first memory means 3 for storing information on a plurality of questionnaires, and a controlling means 5 for controlling the appropriate extraction of information on said questionnaires from said first memory means 3, the transmission of said extracted information on questionnaires to a plurality of said terminals 15 . . . 15 via the connecting means 2, the receiving by participants of information on answers given by the input operation to an inputting means 17 on said terminal 15 based on information on questionnaires displayed on said display means 16, and the storing of said received information on answers in the second memory means 4.

Said controlling means 5 comprises a statistical treatment means 6 for statistically treating each information on answers received from each of the terminals 15 . . . 15 which has been stored in said second memory means 4, and a comparing means 7 for comparing the results processed by said statistical treatment means 6 with a predetermined value (the number of people in this embodiment is one), both means being electrically connected.

Furthermore, in said server 1, it is so arranged that, when the results of statistical treatment of a plurality of information on answers to the same questionnaire by said statistical treatment means 6 which have been transferred from each of said terminals 15 . . . 15 are judged to coincide with said predetermined value by said comparing means 7, said controlling means 5 informs each of said terminals 15 . . . 15 of that the results become the predetermined value via said connecting means 2, and when the results have not reached the predetermined value, information on a questionnaire different from that previously transferred is extracted from said first memory means 3, and said extracted information on questionnaire is transferred to each of the above-described terminals 15 . . . 15 so as to gradually narrow down the value until the predetermined value is judged to be reached by said comparing means 7.

In addition, when the aforementioned value is judged to have become less than a predetermined value by said comparing means 7, said controlling means 5, based on the result obtained by narrowing down the value in the previous step, as described below, controls participants using the terminal 15 to display each individual information on said display means and transfer information by which a priority order of other participants is decided, to whom said participant wants to be introduced or with whom said participant wants to have a conversation, to each of said terminal via said connecting means 2.

The numeral 8 in FIG. 2 is an inputting means of the server 1, which is installed to carry out switching of information on questionnaire as described above and alteration in setting said “predetermined value” as a target value to be narrowed down,

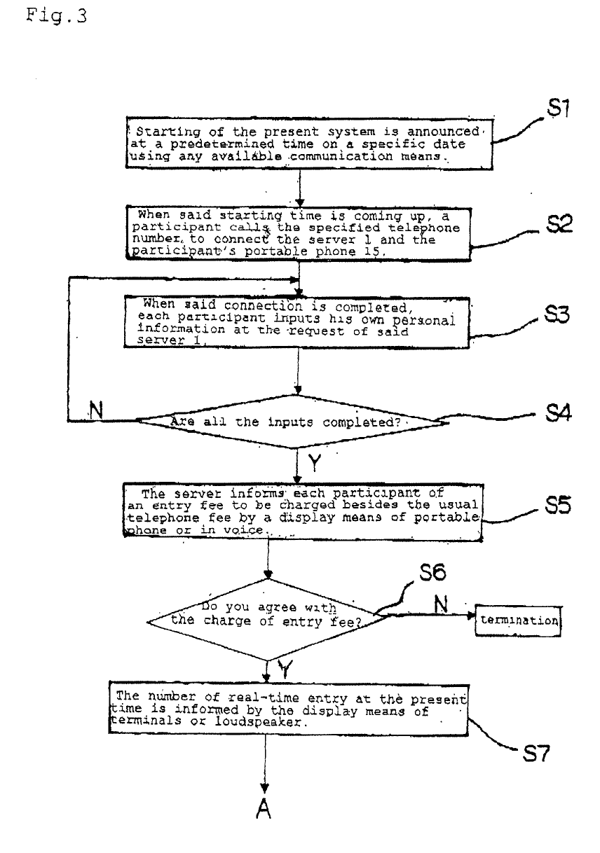

Next, with reference to FIGS. 3 through 5, the proceeding of a method of searching for persons in one embodiment to which this invention is applied.

First, a manager of this server, a manager (management company) of a method of searching for persons, announces to start a program of searching for persons with a catch phrase such as “Don't you want to meet someone just like you who might exist in this world?” at a predetermined time on a specific date via mass communication, periodicals or internet (cf. step S1 in FIG. 3).

And, when said starting time is coming up, each participant calls the specified telephone number to connect the server land the participant's portable phone 15. At this stage, it is not known as to what participants gather or how many participants enter (cf. step S2 in FIG. 3.).

Next, when said terminal 15 and the server 1 are connected, said server 1 transfers a form to input a predetermined personal information to said terminal 15 via said connecting means 2. This data to be transferred is previously stored in said first memory means 3, Referring to said form to input said personal information shown on said display means 16 of said terminal 15, the participant inputs the required personal information by said inputting means 17 (cf. step S3 in FIG. 3).

Until every personal information is input, said server 1 continues to demand the participant to input the information via said terminal 15 (cf. step S4 in FIG. 3).

When all the input of said personal information is completed, the server informs the participant that, when he continues to use this search system, he will be charged with an entry fee in addition to the telephone fee (See step S5 in FIG. 3). To collect said added entry fee, it may be possible to charge it added to the portable phone fee, and entrust the professional collector for the collection of said telephone fee, or, at the participant's option, it is also possible that the card number is input in said personal information for the settlement of the fee on the credit card.

Next, when the participant cannot agree with the addition of the entry fee to the telephone fee, he stops the use of this system for termination. The subsequent search using the present system is continued with that participant who cannot agree omitted (cf. step S6 in FIG. 3).

Then, the server 1 informs the participants who have agreed with the addition of the entry fee of the number of entry at the present time via the display means 16 of said terminal and in voice using a loudspeaker (not shown) Since, on said display means 16 is expressed the increase in the entry number growing every moment, that participant is hardly getting bored while waiting till the number of participants reaches a predetermined number described below (cf. step S7 in FIG. 3)

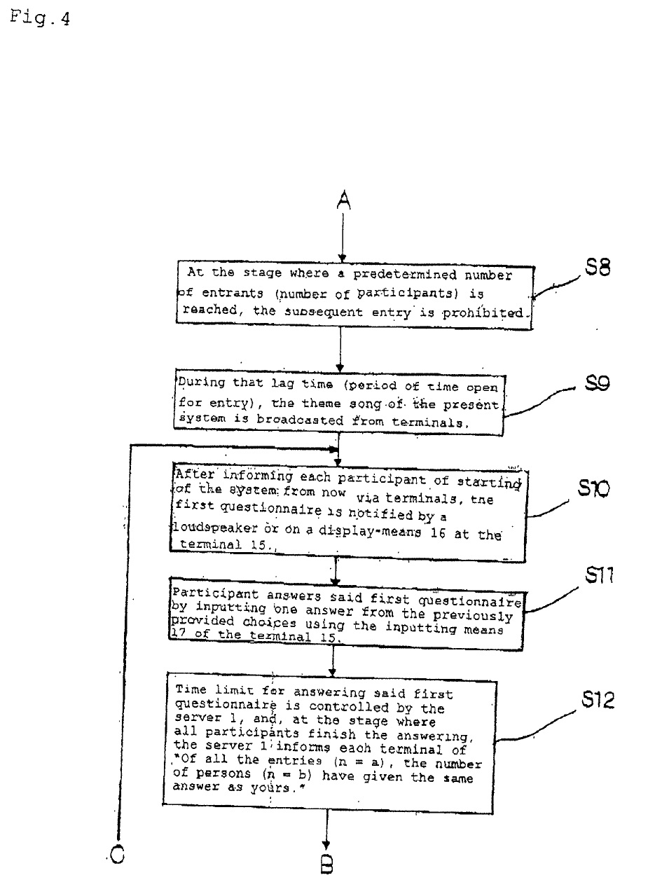

When the number of participants reaches the number predetermined by the server side, it stops the subsequent entry (see step S8 in FIG. 4) Such a limitation by the number of participants is to aim at matching the time for searching in the subsequent searches with the capability of server 1, but, in the case where the capability of server 1 has a reserve, or in the case where the number of members is predetermined because of the membership system, and the server has the capacity to meet this total number of members, it is possible to stop the subsequent entry by limiting the entry time.

And, during said entry accepting time (lag time), said server 1 broadcasts the theme song of this system through said terminals 15. Said lag time for entry is different from the interruption of a new entry in said step S8, but for dealing with a participant under a continual entry (see step S9 in FIG. 4). That is, since the terminal 15 and the server 1 have been already connected through the internet communication line net work 10, so that the entry is the one in the stage which has been initiated, by interruption of entry by said step S8 is meant that the entry of reserved members who want to subsequently connect with the server 1 is interrupted.

In the next step, since a fair number of participants have been determined in the steps hitherto described, the server 1 informs a plurality of participants of the initiation of search for persons via said terminal 15. After giving said notice, the controlling means 5 of said server 1 extracts the first questionnaire from the information on questionnaires stored in said first memory means 3, and displays it on the display means 16 at said terminal 15 via the connecting means 2. For example, a questionnaire such as “In case that an aged person stands in front of you in the electric train, which action out of the followings do you take?” (cf. step S10 in FIG. 4).

After the questionnaire is displayed on the display means 16, choices are subsequently shown on said display means 16. Information on choices to display these choices is previously stored in said first memory means 3. For example, as choices for said exemplified questionnaire may be included those such as “1. neglect it”, “2. give away the seat”, and “3. pretend to sleep”.

Lag time for answering said questionnaire has been previously set by the server 1 side. After the predetermined period of time for answering said questionnaire has passed, said server 1 discontinues receiving the information on answers from the terminal 15, and notifies each terminal of the information, “Of all the entrants (n=a), a number of persons (n=b) have given the same answer as yours.” (cf. the step S12 in FIG. 4).

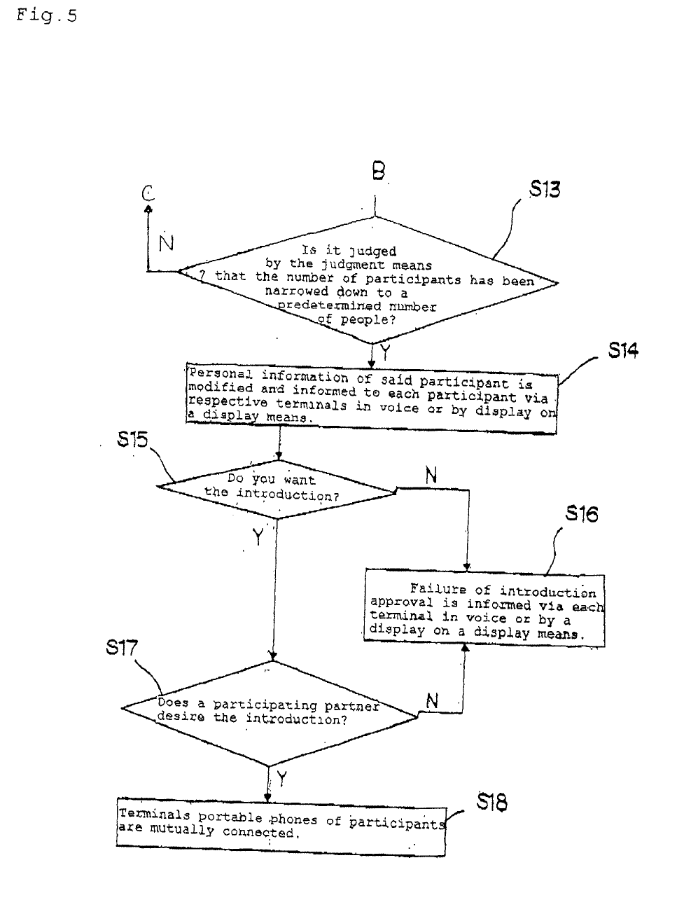

Meanwhile, said server 1 checks every participant whether, of all the present participants, the number of other participants who have given the same answer as that of a particular participant amounts to the predetermined number of people or not by said judgment means 7 (cf. the step S13 in FIG. 5).

Herein, the reason why the server 1 checks every participant as described above is that, for example, given 100 participants as the entrant, in case that said predetermined number is reached by the answer to the first questionnaire if the predetermined number is 2, the search would be continued for the remaining 98 participants as it stands (returning by the symbol C in FIG. 5 to the step S10 in FIG. 4, and receiving the second questionnaire from the server 1), while the narrowed down 2 persons proceed to the step S15, wherein they ascertain whether they want the mutual introduction, and, in case that they agree about the mutual introduction, they further proceed to the step S18 described below.

As described above, in case that said judgment means 7 judges that the number of people reaches the predetermined value, the server 1 then modifies the personal information which has been previously input and displays the thus modified personal information to each participant from the mutual terminal 15 in voice or by a display means (cf. the step S14 in FIG. 5). The reason why the control means 5 of said server 1 once modifies the personal information stored in said second memory means 4 without displaying it as such is that, at this stage, it is not confirmed whether the mutual introduction is really wanted or not. Therefore, the modified personal information has become harmless even though it is notified to the other partner.

Next, via the terminals 15, participants decide whether they want the mutual introduction or not.

If, in the case where even either one of the two participants does not want the introduction at this stage, the server 1 moves to the step S16 in FIG. 5, and notifies that other participant does not want to be introduced through the terminal 15.

And, in the case where participants want to be introduced, the server 1 moves to the step S17 in FIG. 5, and waits for the judgment results as to whether the partner wants to be introduced. When the judgment results in “not want to be introduced”, the server 1 moves to the said S16.

And, in the case where they want the mutual introduction, the system moves to the step S18, automatically connects the terminals 15 with each other via the server 1, so that the mutual vocal communication can be performed since said terminals 15 are the portable phones in this embodiment. Needless to say, it is also possible to construct so as to communicate by the character message, and add a step to make participants to decide which form of communication to be used.

In the above-described method of searching for persons, “another one like me” who has the same way of thinking is searched based on whether the answer to the same questionnaire coincides or not. However, needless to say, the method of searching for persons is not limited to this, and it may be modified so as to search for persons who give the entirely opposite answer, and both persons who give the same and opposite answers.

The present Invention constructed as described above will exert the following effects.

That is, the present invention is a method of searching for persons using a communication means comprising a plurality of the following steps:

(A) a step whereby a plurality of participants connect their terminals with a server in a condition enabling their mutual communication via a communication means,

(B) a step whereby each of said participants inputs personal information thereof into said server from said terminals,

(C) a step whereby said server provides a questionnaire that has been stored therein to each of said participants via said terminals,

(D) a step whereby said participants answer said questionnaire provided by said server using said terminals,

(E) a step whereby said server detects other participants among a plurality of said participants who have given the same or a similar answer and/or other participants a plurality of said participants who have given an opposite answer, and

(F) a step whereby an introductory information is provided via said terminals which has been formed based on said mutual personal information between said participant and said other participants who have given the same or a similar answer, and/or who have given an opposite answer detected by said detection.

Therefore, it is possible for said method to provide an opportunity to contact other participants who have a similar way of thinking as that of a particular participant himself and/or other participants who have an entirely different way of thinking from that of a particular participant himself. Since this method makes it possible to provide such an opportunity, said method is not only applicable, for example, to a game to find “another person just like me” existing in this world whom every body wants to know but also enables a participant to specify a person who has formed an opposite judgment to said participant and contact such a person who has an entirely opposite way of thinking in this world. That is, by this invention, it is possible to be introduced to other participants who have the same or a similar way of thinking as that of a particular participant himself, who have an entirely opposite way of thinking to that of a particular participant himself, or both of other participants who have the same or a similar way of thinking as that of a particular participant himself and who have an entirely opposite way of thinking to that of a particular participant himself.

Although it is fairly difficult to know whether a person has the same way of thinking as that of a particular person himself or an opposite way of thinking to that of a particular person himself because they hardly reveal their true intentions in the ordinary social life and also because they are reserved with each other unless they are old acquaintance, the method of introduction according to this invention is advantageous in that a particular person can be introduced to a stranger after confirming to a certain extent whether said stranger has the same way of thinking as that of a particular person or not. Furthermore, to improve the accuracy of analysis as to whether another person has the same way of thinking as that of a particular person himself, it is possible to do so by posing a questionnaire in accordance with the human psychology.

In the invention, since a common deadline for answering said questionnaire by a plurality of participants has been previously set, the answering to a questionnaire by every participant will proceed simultaneously, so that this invention can provide a reliable method of introduction to be more unintentional and practical as compared with a method of searching for persons who have given a similar answer to that of a particular person and/or who have given an opposite answer to that of a particular person out of information on answers to the same questionnaire corresponding to, for example, about 100 participants which have been provided beforehand.

In the intention, since, after said step (F) is included a step enabling communications between said participant and said other participant or among more than three participants, it is possible to acquire an opportunity to immediately communicate with persons who have been searched out without losing interest. In the case where the communication is made by telephone call, etc., unless the communication can be made immediately, there is a risk for that the contact cannot be made later due to the absence of the other party even though the communication is wanted to be made, but this invention can get rid of these risks.

In the invention, since after said step (E) and prior to said step (F) is included other step for confirming whether said participants desire mutual introductions or not, a careless disclosure of personal information to a stranger can be prevented by providing the introductory information only when two or three participants including said participant himself and other participants who have given the same or a similar answer as that of said participant himself or who have given the opposite answer to that of said participant himself want the introduction, respectively. That is, it is preferable to provide the introductory information only when parties to be introduced want the introduction with each other.

Furthermore, prior to “said step for confirming whether said participants desire the mutual introduction or not” and after “said step (E) wherein the server detects other participants who have given the same or a similar answer out of a plurality of said participants and/or other participants who have given an opposite answer out of a plurality of said participants”, it is also possible to set up a step, whereby those participants can obtain a preliminary introductory information to judge whether they would like to be introduced with each other via said terminals. Such a preliminary introductory information is exemplified by information, which is made from said personal information and unharmful even if disclosed to a stranger, including, for example, the above described “age, gender or profile”.

Needless to say, such a step whereby a preliminary introductory information can be obtained via terminals is not essential in this invention, and the introductory information may be displayed by other devices via no such a step, For example, if said introductory information is only a mail address it is also possible to sever the connection with that introduced participant by changing said mail address, or using a function to reject a mail from a specified mail address which is provided by the latest mail software available from Microsoft Corp.

Since the invention is characterized in that a plurality of questionnaires are provided by the server at said step (C) beforehand, and that said server detects other participants among a plurality of said participants who have given the same or a similar answer and/or other participants out of a plurality of said participants who have given an opposite answer at said step (E), and said steps (C) through (E) are repeated until the detection result reaches a predetermined number of people, it becomes possible to easily narrow down the number of other participants who have the same or a similar way of thinking as a participant himself or who have an opposite way of thinking to said participant himself through such a plurality of questionnaires. If a plurality of questionnaires are not provided, and if the answer to the one questionnaire for one participant himself becomes almost identical to that for a plurality of other participants who simultaneously perform this method of introduction, there will be arisen a problem that the number of persons, even though they are subsequently introduced, becomes too large to be handled, but, as in this method, the number of those persons can be narrowed down by providing a plurality or questionnaires and repeating the answering to said questionnaires until the number of persons who have given the answer reaches a predetermined value.

The present invention, since a method of searching for persons using a communication means, wherein said server detects other participants among a plurality of participants who have given the same or a similar answer and/or other participants among a plurality of participants who have given an opposite answer at said step (E), and said steps (C) through (E) are repeated until the detection result reaches the predetermined number of persons, wherein, in the case where the detection result becomes less than the predetermined number of persons, the server goes back to the detection results of a questionnaire one prior to the above-mentioned questionnaire, and transmits a message to said terminal to direct the particular participant to prioritize other participants to be mutually introduced, and wherein, in the case where other participants to whom mutual introduction is desired are present based on said order of priority which is input from said terminal, the server proceeds to said step (F). Therefore, it can be prevented that the search for persons eventually results in the finding of no one who would fit the requirement.

Since the present invention is characterized in that the steps are included whereby, while said steps (C) through (E) are repeated, said server detects other participants among a plurality of participants who have given the same or a similar answer and/or other participants among a plurality of participants who have given an opposite answer, and notifies each participant of the detection result every time via said terminals. Therefore, in addition to those steps of the above-described invention, the steps whereby steps (C) through (E) are repeated so that said server detects other participants among a plurality of said participants who have given the same or a similar answer and/or other participants among a plurality of said participants who have given an opposite answer, and notifies each participant of the detection result every time via said terminals can be pursued grasping the number of other participants who have the same way of thinking as the participant himself and/or an opposite way of thinking to the participant himself for a particular questionnaire, so that the method including said steps can be carried out with a feeling as if a game were played over a plurality of said questionnaires.

Since the present invention is characterized in that said invention adopts an alternative choice method wherein participants, of their own will, select one answer out of a plurality of answers which have been previously prepared, the process by the server becomes markedly easy by using the alternative choice method which eliminates the necessity of treating differences in the answer expression due to a plurality of participants as compared with the case where the alternative choice method is not employed.

The present invention is characterized in that said invention adopts a method wherein the server makes arrangements so that a participant out of said participant or other participants who expresses the desire to be introduced to the other participant would pay the fee for said communication means after confirming his desire to be introduced to a partner Since a participant who has first expressed the desire to be introduced does not have to bear the communication fee, so that said method can contribute to the decision of the desire to be introduced among participants in a short time.

Since the invention of the server (apparatus) is characterized in that said apparatus comprises:

connecting means for connecting said server with a plurality of terminals enabling them to mutually communicate via a communication means,

a first memory means for storing information on a plurality of questionnaires,

controlling means for controlling the appropriate extraction of information on questionnaires from said memory means, transfer of said extracted information on questionnaires to a plurality of said terminals via said connecting means, receiving of information on answers given based on said questionnaire information by operation of terminals via said connecting means, and storing said information in a second memory means, statistical treatment means for performing a statistical treatment based on answer information received from each terminal which has been stored in said second memory means, and comparing means for comparing the results processed by said statistical treatment means with a pre-set predetermined value, and controlling so that, when said comparing means judges that the result treated with said statistical treatment means coincides with said predetermined value, said controlling means controls so as to inform each of said terminals that the result coincides with the predetermined value via said connecting means, and when the result does not reach the predetermined value, said controlling means controls so as to transfer said information on answers to each of said terminals, again. Therefore, the effects as described above can be expected.

Furthermore, since the mutual encounter of said participants according to the invention is not in the form of interview but the encounter using the communication line, anxiety about what person in another party is can be reduced. That is, although it seems natural that everybody is curious to meet a person (irrespective of gender) who has a similar or the same way of thinking as that of a participant himself, or who has an opposite way of thinking to that of the participant himself, but has a certain degree of uneasiness as to what to do if that person is formidable, such anxiety can be abolished by arranging the meeting through a communication means.

1. A method of searching for persons using a communication means comprising a plurality of the following steps:
(A) a step whereby a plurality of participants connect their terminals with a server in a condition enabling their mutual communication via a communication means,
(B) a step whereby each of said participants inputs personal information thereof into said server from said terminals,
(C) a step whereby said server provides a questionnaire that has been stored therein to each of said participants via said terminals,
(D) a step whereby said participants answer to said questionnaire provided by said server using terminals,
(E) a step whereby said server detects other participants among a plurality of said participants who have given the same or a similar answer and/or other participants among a plurality of said participants who have given an opposite answer, and
(F) a step whereby an introductory information prepared based on said mutual personal information is provided via said terminals between said participant and other participants who have given the same or a similar answer and/or who have given an opposite answer detected by said detection.

2. The method of searching for persons using a communication means according to claim 1, wherein a common deadline for answering said questionnaire by a plurality of participants has been previously set.

3. The method of searching for persons using a communication means according to claim 1, wherein said method comprises other step after the said step (F) which enables communications between both said participant and said another participant or among more than 3 participants.

4. The method of searching for persons using a communication means according to claim 1, wherein said method comprises other step, after said step (E) and prior to said step (F), for confirming whether said participants desire mutual introductions or not.

5. The method of searching for persons using a communication means according to claim 1, wherein the server has prepared a plurality of various questionnaires at said step (c) beforehand, and the server detects other participants among a plurality of participants who have given the same or a similar answer and/or other participants among a plurality of participants who have given an opposite answer at said step (E), and said steps (C) through (E) are repeated until the detection result reaches a predetermined number of people.

6. The method of searching for persons using a communication means according to claim 5, wherein said server detects other participants among a plurality of participants who have given the same or a similar answer and/or other participants among a plurality of participants who have given an opposite answer at said step (E), and said steps (C) through (E) are repeated until the detection result reaches the predetermined number of people,
wherein, in the case where said detection result becomes less than the predetermined number of people, the server goes back to the detection results of a questionnaire one prior to that questionnaire, and transmits a message to said terminal to direct the particular participant to prioritize other participants to be mutually introduced, and wherein, in the case where other participants to whom mutual introduction is desired are present based on said order of priority, the server proceeds to said step (F).

7. The method of searching for persons using a communication means according to claim 5, wherein said method comprises steps whereby, while steps (C) through (E) are repeated, the server detects other participants among a plurality of participants who have given the same or a similar answer and/or other participants among a plurality of participants who have given an opposite answer, and notifies each participant of the detection results each time via said terminals.

8. The method of searching for persons using a communication means according to claim 6, wherein said method comprises steps whereby, while steps (C) through (E) are repeated, the server detects other participants among a plurality of participants who have given the same or a similar answer and/or other participants among a plurality of participants who have given an opposite answer, and notifies each participant of the detection results each time via said terminals.

9. The method of searching for persons using a communication means according to claim 1, wherein said method adapts a system of selecting one answer out of a plurality of answers of participant's own will, which have been previously prepared for said questionnaires.

10. The method of searching for persons using a communication means according to claim 1, wherein said server sets up a system by which, a participant out of said participant or other participants who expresses the desire to be introduced to the other participant would pay the fee for said communication means after confirming his desire to be introduced to a partner.

11. A server having the following constructions, comprising:
connecting means for connecting said server with a plurality of terminals enabling them to mutually communicate via a communication means,
a first memory means for storing information on a plurality of questionnaires,
controlling means for controlling the appropriate extraction of information on questionnaires from said memory means, transfer of said extracted information on questionnaires to a plurality of said terminals via said connecting means, receiving of information on answers given based on said questionnaire information by operation of terminals via said connecting means, and storing said information in a second memory means,
statistical treatment means for performing a statistical treatment based on answer information received from each terminal which has been stored in said second memory means, and
comparing means for comparing results processed by said statistical treatment means with a pre-set predetermined value, and
controlling, so that, when said comparing means judges that the result treated with said statistical treatment means coincides with said pre-set predetermined value, said controlling means controls so as to inform each of said terminals that the result coincides with the predetermined value via said connecting means, and when the result does not reach the predetermined value, said controlling means controls so as to transfer said information on answers to each of said terminals, again.
